(19) United States
(12) Patent Application Publication
(10) Pub. No.: US 2026/0045258 A1
(43) Pub. Date: Feb. 12, 2026

(54) COMMAND DETECTION FOR CONTINUOUS CONVERSATION WITH DIGITAL ASSISTANTS USING AUTO ENCODERS AND JOINT LAYERS

(71) Applicant: Samsung Electronics Co., Ltd., Suwon-si (KR)

(72) Inventors: Neha Barde, Mountain View, CA (US); Srinivasa Rao Ponakala, Sunnyvale, CA (US); Patrick Hegarty, San Francisco, CA (US); Aditya Jajodia, Sunnyvale, CA (US)

(21) Appl. No.: 18/939,304

(22) Filed: Nov. 6, 2024

Related U.S. Application Data
(60) Provisional application No. 63/680,889, filed on Aug. 8, 2024.

(51) Int. Cl. G10L 15/32; G10L 15/06; G10L 15/16

(52) U.S. Cl. CPC G10L 15/32; G10L 15/063; G10L 15/16; G10L 2015/0635

(57) ABSTRACT

A method includes receiving a user utterance. The method also includes providing the user utterance to a first convolutional recurrent neural network (RNN) classifier and a second convolutional RNN classifier to process the user utterance and provide outputs to a first joint layer. The method also includes providing the user utterance to an automated speech recognition (ASR) model to process the user utterance and provide a text transcript to a text classifier. The method also includes combining the outputs from the first convolutional RNN classifier and the second convolutional RNN classifier using the first joint layer. The method also includes combining outputs from the first joint layer and the text classifier using a second joint layer. The method also includes determining an audio class based on a result from the second joint layer, wherein the audio class indicates whether the user utterance includes speech intended for further processing.

### CROSS-REFERENCE TO RELATED APPLICATION AND PRIORITY CLAIM

This application claims priority under 35 U.S.C. § 119(e) to U.S. Provisional Patent Application No. 63/680,889 filed on Aug. 8, 2024, which is hereby incorporated by reference in its entirety.

### TECHNICAL FIELD

This disclosure relates generally to machine learning systems. More specifically, this disclosure relates to command detection for continuous conversation with digital assistants using auto encoders and joint layers.

### BACKGROUND

With respect to continuous conversations, virtual assistants are expected to understand what the user wants to execute and need to keep the conversation going with the user as though an actual human is assisting the user with tasks. Consequently, the microphone used by the user often needs to be kept open for a period of time after the initial wakeup so that the virtual assistant is continuously listening, which can lead to poor user experience if the voice assistant processed unintended audio such as background noise or utterances.

### SUMMARY

This disclosure relates to a command detection for continuous conversation with digital assistants using auto encoders and joint layers.

In one example, a method includes receiving a user utterance via an audio input device. The method also includes providing the user utterance to a first convolutional recurrent neural network (RNN) classifier and a second convolutional RNN classifier to process the user utterance and provide outputs to a first joint layer. The method also includes providing the user utterance to an automated speech recognition (ASR) model to process the user utterance and provide a text transcript to a text classifier. The method also includes combining the outputs from the first convolutional RNN classifier and the second convolutional RNN classifier using the first joint layer. The method also includes combining outputs from the first joint layer and the text classifier using a second joint layer. The method also includes determining an audio class based on a result from the second joint layer, wherein the audio class indicates whether the user utterance includes speech intended for further processing.

In another example, an electronic device includes at least one processing device. The at least one processing device is configured to receive a user utterance via an audio input device. The at least one processing device is also configured to provide the user utterance to a first convolutional RNN classifier and a second convolutional RNN classifier to process the user utterance and provide outputs to a first joint layer. The at least one processing device is also configured to provide the user utterance to an ASR model to process the user utterance and provide a text transcript to a text classifier. The at least one processing device is also configured to combine the outputs from the first convolutional RNN classifier and the second convolutional RNN classifier using the first joint layer. The at least one processing device is also configured to combine outputs from the first joint layer and the text classifier using a second joint layer. The at least one processing device is also configured to determine an audio class based on a result from the second joint layer, wherein the audio class indicates whether the user utterance includes speech intended for further processing.

In yet another example, a non-transitory machine readable medium comprises instructions that when executed cause at least one processor of an electronic device to receive a user utterance via an audio input device. The instructions, when executed, further cause the at least one processor to provide the user utterance to a first convolutional RNN classifier and a second convolutional RNN classifier to process the user utterance and provide outputs to a first joint layer. The instructions, when executed, further cause the at least one processor to provide the user utterance to an ASR model to process the user utterance and provide a text transcript to a text classifier. The instructions, when executed, further cause the at least one processor to combine the outputs from the first convolutional RNN classifier and the second convolutional RNN classifier using the first joint layer. The instructions, when executed, further cause the at least one processor to combine outputs from the first joint layer and the text classifier using a second joint layer. The instructions, when executed, further cause the at least one processor to determine an audio class based on a result from the second joint layer, wherein the audio class indicates whether the user utterance includes speech intended for further processing.

In one or more of the above examples, the first joint layer uses concatenation, cross attention, or context layers to combine the outputs from the first convolutional RNN classifier and the second convolutional RNN classifier, and the second joint layer uses concatenation, cross attention, or context layers to combine the outputs from the first joint layer and the text classifier.

In one or more of the above examples, the first convolutional RNN classifier is trained by performing pretraining of a first autoencoder that receives and processes clean speech training audio, and the second convolutional RNN classifier is trained by performing pretraining of a second autoencoder that receives and processes noisy training audio.

In one or more of the above examples, the first convolutional RNN classifier is provided with seed weights from the first autoencoder during training, and the second convolutional RNN classifier is provided with seed weights from the second autoencoder during training.

In one or more of the above examples, the first autoencoder includes a first convolutional RNN encoder to receive the clean speech training audio and a first convolutional RNN decoder to receive an output from the first convolutional RNN encoder, and the second autoencoder includes a second convolutional RNN encoder to receive the noisy training audio, and a second convolutional RNN decoder to receive an output from the second convolutional RNN encoder.

In one or more of the above examples, the convolutional RNN encoder is considered trained when a difference between input features to the convolutional RNN encoder and output features of the convolutional RNN decoder is minimized.

In one or more of the above examples, the first convolutional RNN classifier, having the seed weights from the first autoencoder, the second convolutional RNN classifier, having the seed weights from the second autoencoder, and the text classifier are jointly trained using a same audio dataset, including the first convolutional RNN classifier the second convolutional RNN classifier are trained using audio samples from the same audio dataset, and the text classifier is trained using text transcriptions created using the same audio dataset.

In one or more of the above examples, the text classifier is one of an RNN classifier trained with a dataset including text transcripts, or a text classifier created by finetuning a pre-trained model with a dataset including text transcripts.

In one or more of the above examples, the audio class is determined based on a confidence score output by the second joint layer.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example command detection system in accordance with this disclosure;

FIG. 3 illustrates an example command detection training architecture in accordance with this disclosure;

FIG. 4 illustrates another example command detection training architecture in accordance with this disclosure;

FIG. 5 illustrates an example method for command detection model training in accordance with this disclosure;

FIG. 6 illustrates an example command detection deployment architecture in accordance with this disclosure; and

FIG. 7 illustrates an example method for performing command detection in accordance with this disclosure.

### DETAILED DESCRIPTION

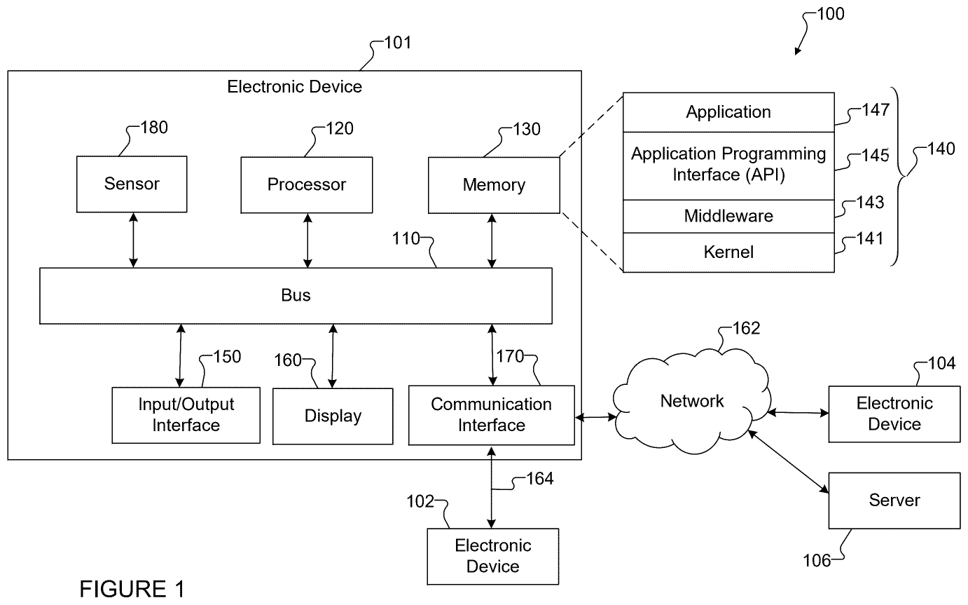

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, with respect to continuous conversations, virtual assistants are expected to understand what the user wants to execute and need to keep the conversation going with the user as though an actual human is assisting the user with tasks. Consequently, the microphone used by the user often needs to be kept open for a period of time after the initial wakeup so that the virtual assistant is continuously listening.

For the actions that are meant for execution by the virtual assistant, there is also expected to be a seamless trigger of the workflow. But voice assistants often provide programmed responses like “I didn't understand,” “I can't do that now,” or any similar “unknown or unsupported intent” responses. In case of single-intent-execution wakeup, the main points of failure tend to be the false wakeups, such as due to the voice assistant hearing a word similar to the wake word or due to an accidental button press.

However, in the case of continuous conversation, after the first wakeup, the microphone stays open and key word detectors or verifiers can no longer be relied on to mitigate any unintended commands. Thus, if the voice assistant keeps responding with “unknown intent” responses, then the user experience is ruined as this gives the user the impression that the voice assistant is eavesdropping. On the other hand, if the voice assistant seamlessly triggers a command which the user did not intend, then that causes a bad user experience overall.

For example, if the user is using the voice assistant but someone at the far side of the room yells out “Call Mom” (which is clearly not meant for the voice assistant execution), and if, in response, the voice assistant were to execute “Call Mom” for the user, then that could become increasingly annoying to the user of the voice assistant.

The present disclosure alleviates issues and improves continuous conversation workflows by providing for command detection for continuous conversation with digital assistants using auto encoders and joint layers. In previous approaches, there is no component that distinguishes between a device directed command vs non-device directed speech/noise. Without this component, a voice assistant will either “fail silently” or utter a response when the voice assistant was not supposed to chime in. This leads to poor user experience and sense of intrusiveness for the user. With continuous conversations, the commands the user provides to the voice assistant are not restricted, which means this problem extrapolates to not just distinguishing between natural speech based commands and short well-defined commands, but to also distinguish between device directed natural speech vs background natural speech.

The various embodiments of this disclosure provide a command detection model that caters to both natural speech-based commands and concise false trigger mitigation for commands. The various embodiments of this disclosure also help to prevent user data from leaving the device and going to the server unnecessarily by properly detecting when speech is meant for the virtual assistant and when speech is not meant for the virtual assistant, avoiding the device microphone from being turned on and recording speech at improper times. This not only helps preserve user privacy, but also ensures that device resources are not wasted on processing unwanted data, such as a personal conversation between two humans after a voice assistance wakeup.

To deploy voice assistant models on consumer devices, the model size typically needs to be small (such as less than 5 MB) to ensure that it can be seamlessly deployed on the device, all while ensuring a high “correct acceptance rate” (CAR) (true positives accepted as device directed commands) and a low “false acceptance rate” (FAR) (false positives accepted as device directed commands). The command detection model(s) of this disclosure maintains a small size, while achieving high correct acceptance rates and low false acceptance rates.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. Also note that while some of the embodiments discussed below are described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to command detection for continuous conversation with digital assistants.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to command detection for continuous conversation with digital assistants. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensors 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensors 180 can further include an inertial measurement unit, which can include one or more accelerometers, gyroscopes, and other components. In addition, the sensors 180 can include a control circuit for controlling at least one of the sensors included here. Any of these sensors 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to command detection for continuous conversation with digital assistants. The server 106 may further receive inputs (such as data samples to be used in training machine learning models) and manage such training by inputting the samples to the machine learning models, receive outputs from the machine learning models, and execute learning functions (such as loss functions) to improve the machine learning models.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

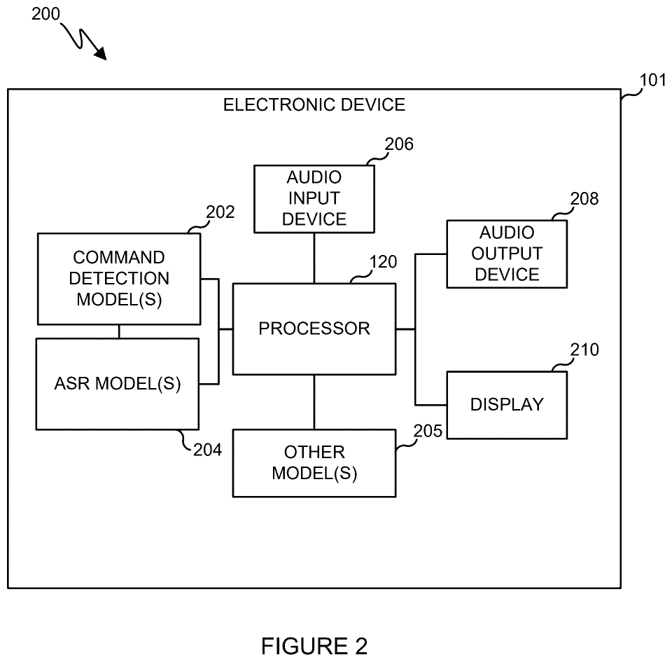

FIG. 2 illustrates an example command detection system 200 in accordance with this disclosure. For ease of explanation, the system 200 is described as involving the use of the electronic device 101 in the network configuration 100 of FIG. 1. However, the system 200 may be used with any other suitable electronic device(s), such as the server 106, and in any other suitable system(s).

As shown in FIG. 2, the system 200 includes the electronic device 101, which includes the processor 120. The processor 120 is operatively coupled to or otherwise configured to use one or more machine learning models, such as at least one command detection model 202 and/or at least one automated speech recognition (ASR) model 204. The processor 120 can also be operatively coupled to or otherwise configured to use one or more other models 205, such as one or more wake word detection models, natural language understanding (NLU) models, other models supporting a virtual assistant, etc. It will be understood that the machine learning models 202, 204, 205 can be stored in a memory of the electronic device 101 (such as the memory 130) and accessed by the processor 120 to perform automated speech recognition tasks, like virtual assistant tasks. However, the machine learning models 202, 204, 205 can be stored in any other suitable manner. The system 200 also includes an audio input device 206 (such as a microphone), an audio output device 208 (such as a speaker or headphones), and a display 210 (such as a screen or a monitor like the display 160).

As described in this disclosure, the command detection model 202 can include various components or sub-models, such as a first convolutional recurrent neural network (RNN) classifier seeded with weights created using clean speech audio samples, second convolutional RNN classifier seeded with weights created using noisy audio samples, and a text classifier. The first convolutional RNN classifier, the second convolutional RNN classifier, and the text classifier of the command detection model 202 can be jointly trained using a same audio training dataset.

As described in this disclosure, once trained, the first and second convolutional RNN classifiers can receive audio inputs provide via the audio input device 206, and process the audio inputs to each provide outputs that are fed to a first joint layer of the command detection model 202 that combines the outputs of the first and second convolutional RNN classifiers to create a combined output. The audio inputs provided via the audio input device 206 are also provided to the ASR model 204 to convert the audio to text transcriptions. The text classifier of the command detection model 202 receives the text transcriptions and processes the text transcriptions. A second joint layer receives both the combined output from the first joint layer and the outputs from the text classifier, and combines the outputs to provide a classification results for the audio. For example, the command detection model 202 can classify whether the audio recorded using the audio input device 206 is intended for use by the system 200, such as for use by a virtual assistant application, or whether the audio is not intended for use by the system 200, i.e., whether the audio is far away audio or “background noise.”

Because a continuous conversation assistant may leave the audio input device 206 open to continuously receive audio from a user so that a natural conversation flow can be provided (as opposed to processing a sentence form a user, stopping recording using the audio input device 206, receiving a next utterance from the user, initiating recording again, and so on), the command detection model 202 is trained to accurately identify when recorded audio is meant for the system 200 so that the system 200 does not act on audio that is unintended for the system 200. For example, based on the training of the command detection model 202, if a user has begun a continuous conversation, and audio is received via the audio input device 206 that includes an utterance of a phrase such as “call mom,” the command detection model 202 can determine whether the utterance was directed to the system 200, or if the utterance is background noise that should not be processed. If, based on the output of the command detection model 202, it is determined the utterance was meant for the system 200, the processor 120 can act on the utterance, such as providing an answer, asking a follow up question, or initiation a device action, such as instructing the audio output device 208 to output “calling Mom,” (in the case of the above example), which can also include the processor 120 also causing a phone application or other communication application to begin a communication session with a “mom” contact stored on the electronic device 101 or otherwise in association with the user of the electronic device 101. As another example, if it is determined that an utterance of “start a timer” is intended for the system 200, the processor 120 may instruct execution of a timer application and display of a timer on the display 210 of the electronic device 101.

If, however, it is determined using the command detection model 202 that the received audio is not intended for the system 200, the audio can be ignored/discarded. In such cases, the audio input device 206 can remain open to continue the conversation with the user, without the conversation being interrupted by the system 200 acting on the received audio. For instance, the command detection model 202 avoids instances of bad or annoying user experiences such as responding to the received audio by initiating an unintended device task, providing an answer or asking a follow up question related to the unintended utterance, outputting an “unknown or unsupported intent” response, etc. In some embodiments, if the audio input device 206 is open for a predetermined period of time without receiving any audio classified as intended audio, the processor 120 may close the audio input device 206 and/or otherwise cease the continuous conversation.

Although FIG. 2 illustrates one example of a command detection system 200, various changes may be made to FIG. 2. For example, the audio input device 206, the audio output device 208, and the display 210 can be connected to the processor 120 within the electronic device 101, such as via wired connections or circuitry. In other embodiments, the audio input device 206, the audio output device 208, and the display 210 can be external to the electronic device 101 and connected via wired or wireless connections. Also, in some cases, the command detection model 202 (as well as its described components or sub-models), the ASR model 204, as well as one or more of the other machine learning models 205, can be stored as separate models called upon by the processor 120 to perform certain tasks or can be included in and form a part of one or more larger machine learning models. In some embodiments, the command detection model 202, the ASR model 204, and the one or more other machine learning models 205 can all be stored by the electronic device 101, i.e., stored completely on-device. In some embodiments, one or more of the machine learning models 202, 204, 205, can be stored remotely from the electronic device 101, such as on the server 106. Here, the electronic device 101 may transmit requests including inputs (such as captured audio data) to the server 106 for processing of the inputs using the machine learning models, and the results can be sent back to the electronic device 101 for further processing. In addition, in some embodiments, the electronic device 101 can be replaced by the server 106, which receives audio inputs from a client device and transmits instructions back to the client device to execute functions associated with instructions included in utterances.

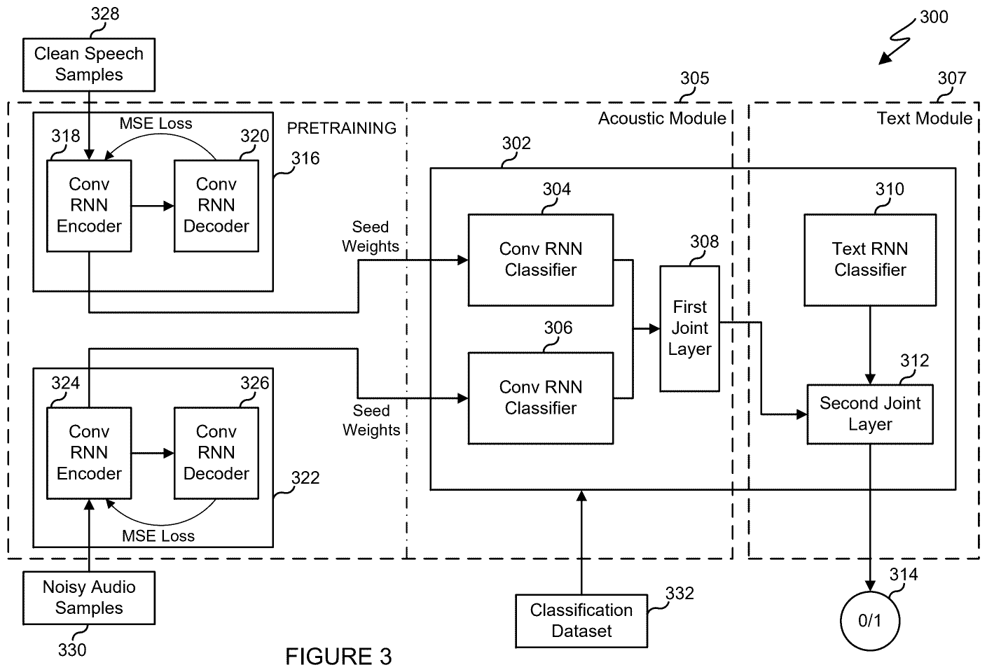

FIG. 3 illustrates an example command detection training architecture 300 in accordance with this disclosure. For ease of explanation, the architecture 300 shown in FIG. 3 is described as being implemented on or supported by the server 106 in the network configuration 100 of FIG. 1. However, the architecture 300 shown in FIG. 3 could be used with any other suitable device(s) and in any other suitable system(s), such as when the architecture 300 is implemented on or supported by the electronic device 101.

As shown in FIG. 3, the architecture 300 includes a command detection model 302, which, when trained, can be the command detection model 202 described with respect to FIG. 2. The command detection model 302 includes a first convolutional RNN classifier 304 and a second convolutional RNN classifier 306. During processing of audio inputs by the command detection model 302, the audio inputs are processed by each of the first convolutional RNN classifier 304 and the second convolutional RNN classifier 306, and their outputs are combined using a first joint layer 308 using, for example, concatenation, cross attention, or context layers to create combined outputs from the outputs of the first convolutional RNN classifier 304 and the second convolutional RNN classifier 306. The first joint layer 308 can be considered a final fully connected layer of the first convolutional RNN classifier 304 and the second convolutional RNN classifier 306, taking as inputs the embeddings from the first convolutional RNN classifier 304 and the second convolutional RNN classifier 306, and outputting concatenated, cross-attention-based or context layer-based combination embeddings. The first convolutional RNN classifier 304, the second convolutional RNN classifier 306, and the first joint layer 308 logically can make up an acoustic module 305.

The architecture 300 also includes a text RNN classifier 310 that processes text transcriptions, such as text transcriptions of audio samples. Outputs from the text RNN classifier 310, as well as the combined outputs from the first joint layer 308, are provided to a second joint layer 312, to combine the outputs using a technique such as concatenation, cross attention, or context layers. In various embodiments, the first joint layer 308 and the second joint layer 312 can use the same combination technique, e.g., both use concatenation, or different techniques, e.g., the first joint layer 308 uses concatenation and the second joint layer 312 uses cross attention. The second joint layer 312 outputs a final audio classification result 314, to indicate whether an input audio is classified as intended audio (“1”) or unintended audio (e.g., background noise) (“0”). The second joint layer 312 can be considered a final fully connected layer of the text RNN classifier 310 and first joint layer embeddings, taking as inputs the embeddings from the text RNN classifier 310 and the first joint layer 308, and outputting a concatenated, cross-attention-based or context layer-based combination that provides the final audio classification result 314, i.e., a class decision label based on a confidence score. The text RNN classifier 310 and the second joint layer 312 can logically make up a text module 307.

As shown in FIG. 3, during training, a pretraining step is first performed using a first autoencoder 316, the first autoencoder 316 including a first convolutional RNN encoder 318 and a first convolutional RNN decoder 320, and a second autoencoder 322, the second autoencoder 322 including a second convolutional RNN encoder 324 and a second convolutional RNN decoder 326. The convolutional RNN encoders 318, 324 encode an input audio signal into a latent feature representation and output the latent feature representation. The convolutional RNN decoders 320, 326 are used to reconstruct the original audio using the encoded feature representation. The autoencoders 316, 322 are trained to individually learn what a particular class of data looks like, essentially treating anything that does not resemble the respective classes' characteristic as an anomaly. This is accomplished by training the first autoencoder 316 using clean speech samples 328 (audio training samples including clean speech reminiscent of speech intended for the virtual assistant) and by training the second autoencoder 322 using noisy audio samples 330 (audio training samples of noisy environments, such as audio with no speech, but including street noise, trains, wind noise, busy environments (e.g., bars/restaurants), etc.

In various embodiments, the first and second convolutional RNN encoders 318, 324 use an encoder architecture that can be a replica of a classifier architecture, and the first and second convolutional RNN decoders 320, 326 can be reconstruction decoders. This provides better CAR and FAR scores than if a classifier were to be directly trained for all different types of positive and negative data. As shown in FIG. 3, the convolutional RNN encoders 318, 324 can be trained, and their weights adjusted, using a mean squared error (MSE) loss until both begin obtaining accurate classification results (i.e., close to ground truths of their respective clean speech samples 328 and noisy audio samples 330). That is, the difference between the decoder generated signal and the original signal is used to train the encoders 318, 324 to get better at representing the features of their respective datasets 328, 330. Using the decoders 320, 326 in this way enhances the feature representation provided by the encoders 318, 324. At the lowest MSE, it can be determined that the encoder has learned the most important features of the training audio such that the decoder is able to generate the signal more accurately.

Once the pretraining of the first and second autoencoders 316, 322 is complete, the actual classifiers that will be used during inferencing, the first and second convolutional RNN classifiers 304, 306, are first finetuned by seeding the weights of the convolutional RNN encoders 318, 324 to the first and second convolutional RNN classifiers 304, 306. The seeded weights are the initial weights prior to further training of the first and second convolutional RNN classifiers 304, 306. For instance, the first convolutional RNN classifier 304 is seeded with the weights of the pretrained first convolutional RNN encoder 318 that was trained to recognize the features of clean speech using the clean speech samples 328. The second convolutional RNN classifier 306 is likewise seeded with the weights of the pretrained second convolutional RNN encoder 324 that was trained to recognize the features of noisy audio using the noisy audio samples 330. To enable the weight seeding, the encoders 318, 324 can have the same architecture as the classifiers 304, 306. In prior approaches, finetuning has been performed by transferred learning. Seeding the weights of the first and second convolutional RNN classifiers 304, 306 provides several advantages, such as the ability to maintain a small model size that is lightweight enough for on-device deployment, the capability of training the model to understand the acoustics of natural speech, noise, and noise-augmented natural speech without directly feeding the these broader data characteristics, and the ability to provide for consistent behavior in the model.

After the pretraining step is complete and the weights are seeded to the first and second convolutional RNN classifiers 304, 306, the components or sub-models of the command detection model 302 are jointly trained using a classification dataset 332 to better understand the differences between intended audio and unintended audio and to accurately classify audio inputs as intended audio and unintended audio. The classification dataset 332 can include audio samples and associated transcription samples of the audio samples, and can include both positive (graded valid) samples and negative (graded invalid) samples. The text data for the positive class can be provided by graders and text data for the negative class can be pre-inverse text normalization (ITN) ASR transcriptions.

As described above, since the first convolutional RNN classifier 304 is initially seeded with weights from the first autoencoder 316 trained on clean speech data, the first convolutional RNN classifier 304 is better able to identify clean speech acoustics in the training classification dataset 332. Additionally, since the second convolutional RNN classifier 306 is initially seeded with weights from the second autoencoder 322 trained on noisy audio acoustics, the second convolutional RNN classifier 306 is better able to identify noise in the training classification dataset 332. The first and second convolutional RNN classifiers 304, 306 are both trained on the audio samples in the classification dataset 332, and the text RNN classifier is trained on the associated text transcriptions in the classification dataset 332.

As described above, output embeddings from the first and second convolutional RNN classifiers 304, 306 are combined via the first joint layer 308. This provides a more comprehensive and robust probability score on the acoustic data. While the acoustic information provides important information on the input, the architecture 300 includes the text RNN classifier 310 to provide text support to understand what is being said, in order to make a more accurate decision. The outputs of the first joint layer 308 and the output embeddings of the text RNN classifier 310 are combined via the second joint layer 312, and the classification result 314 is compared against the ground truths in the classification dataset 332 to minimize the differences between the classification results 314 and the ground truths. For the first and second joint layers 308, 312, random weights can be initialized, and the model can learn the weightage given to each classifier when combining the outputs, based on the labels given during training.

Based on this, the text RNN classifier 310 is jointly trained and adjusted along with the first and second convolutional RNN classifiers 304, 306. This ensures the command detection model 302 operates with the full context of what is being said (content of the conversation) as well as how it is being said (acoustics of the conversation), in order to product a highly accurate probability score. For example, if each classifier operated independently, rather than being trained together and using the joint layers 308, 312, if “call Mom” was uttered by a random person from the far side of the room, the first convolutional RNN classifier 304 may classify it as being far away audio or “background noise,” and the second convolutional RNN classifier 306 may also classify the audio as not near-field and thus give the audio a low probability of being from a positive class, but the text RNN classifier 310 may be inclined to classify the audio as a true command given the utterance text, divorced from the acoustic information, appears to be a command. However, by combining these decisions from each of the classifiers 304, 306, 310, the command detection model 302 is able to accurately classify the audio as not being device-directed audio. This is the advantage of training the classifiers 304, 306, 310 together and on the same acoustic and corresponding text dataset 332, as it allows the command detection model 302 to learn the full context of the audio and learn the differences in features between a device-directed command vs non-device directed command.

The command detection model 302 can thus be a standalone and compact module that consumes the output of a currently present system e.g., an on-device ASR model. In various embodiments, the first and second joint layers 308, 312 of the command detection model 302 can be configured to use different combinations of techniques, such as different combinations of concatenation, context layer, and cross attention approaches, depending on the needs of the system or based on accuracy results achieved during training. Examples of the various combinations can include the following combinations shown in Table 1.

TABLE 1
Method of Combination Using Joint Layers

| | |
|---|---|
| 1 | Concatenate/Concatenate |
| 2 | Context/Context |
| 3 | Cross Attention/Cross Attention |
| 4 | Concatenate/Context |
| 5 | Concatenate/Cross Attention |
| 6 | Context/Cross Attention |
| 7 | One joint layer (Positive Acoustic + Negative Acoustic +Text model) |
| 8 | One context layer for positive acoustic and text combination and |
| | another for negative acoustic and text combination, followed by a |
| | concatenation of the two |
| 9 | One context layer for positive acoustic and text combination and |
| | another for negative acoustic and text combination, followed by a |
| | context layer combining the two |

Context layers can be used to provide more importance to different classifiers, while cross-attention can be used to identify which features to give more attention to (i.e., weight higher). For cross-attention, multi-head attention, such as with 8 attention heads, can be used. For context layers, a context layer can be a layer with randomly initialized weights for the two combining elements, where the weights are learned based on the training dataset.

As shown in Table 1, various technique combinations can be used. For instance, as shown in line 5 of Table 1, a concatenation of the outputs of the acoustic models could be performed by the first joint layer 308, followed by a cross-attention layer of the second joint layer 312 that combines the acoustic outputs from the first joint layer and the text outputs from the text RNN classifier 310 As another example, as shown in line 8 of Table 1, context layers separately combining the outputs for the first convolutional RNN classifier 304 and the second convolutional RNN classifier 306 with the text model can be used, followed by a final concatenation of the resulting layers.

Although FIG. 3 illustrates one example of a command detection training architecture 300, various changes may be made to FIG. 3. For example, various components and functions in FIG. 3 may be combined, further subdivided, replicated, or rearranged according to particular needs. Also, one or more additional components and functions may be included if needed or desired.

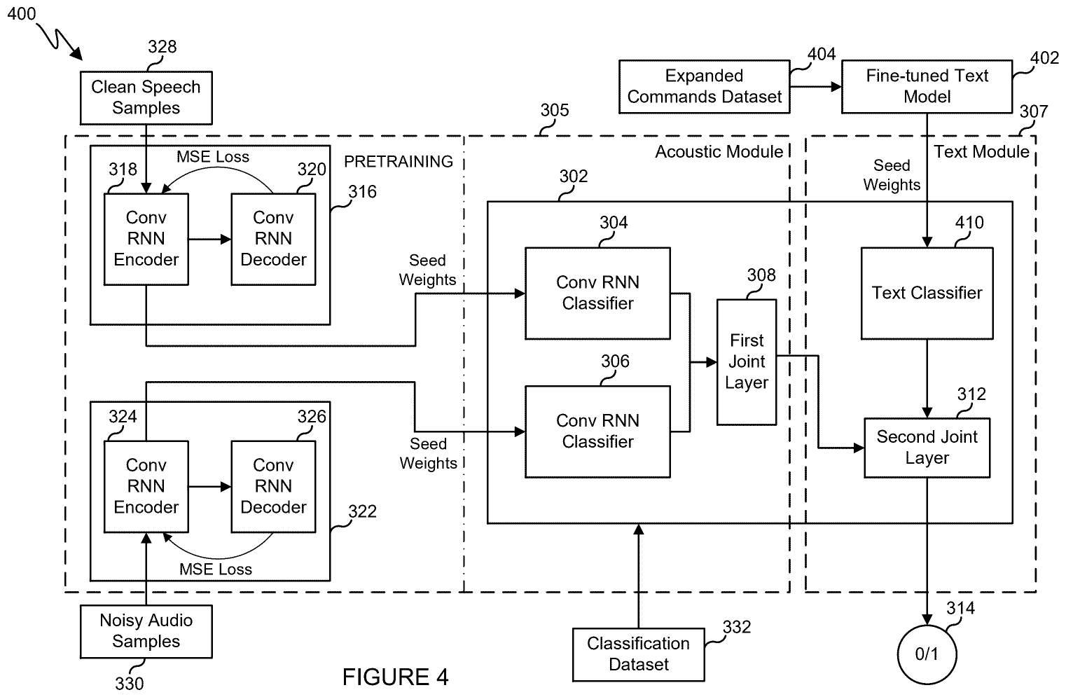

FIG. 4 illustrates another example command detection training architecture 400 in accordance with this disclosure. For ease of explanation, the architecture 400 shown in FIG. 4 is described as being implemented on or supported by the server 106 in the network configuration 100 of FIG. 1. However, the architecture 400 shown in FIG. 4 could be used with any other suitable device(s) and in any other suitable system(s), such as when the architecture 400 is implemented on or supported by the electronic device 101.

As shown in FIG. 4, the architecture 400 is similar to the architecture 300, and includes the components of the architecture 300, such as the autoencoders 316, 322 using during pretraining and the command detection model 302 that includes the first and second convolutional RNN classifiers 304, 306, the first joint layer 308, and the second joint layer 312. As shown in FIG. 4, in some embodiments of this disclosure, a text classifier 410 can be used that is created via a separate finetuning process.

As shown in FIG. 4, the text classifier 410 can be created by finetuning an external text model 402 with a dataset including text transcripts. For example, the external text model 402 can be external to the command detection model 302, and can be trained to see more types of text data using an expanded commands dataset 404. In some embodiments, the external model can be a large pretrained model that is fine-tuned or can be a model built from scratch and trained on various positive and negative datasets. As further shown in FIG. 4, the weights from the external text model 402 can be seeded to the text classifier 410. From there, the training process can follow as described with respect to FIG. 3.

Although FIG. 4 illustrates one example of a command detection training architecture 400, various changes may be made to FIG. 4. For example, various components and functions in FIG. 4 may be combined, further subdivided, replicated, or rearranged according to particular needs. Also, one or more additional components and functions may be included if needed or desired.

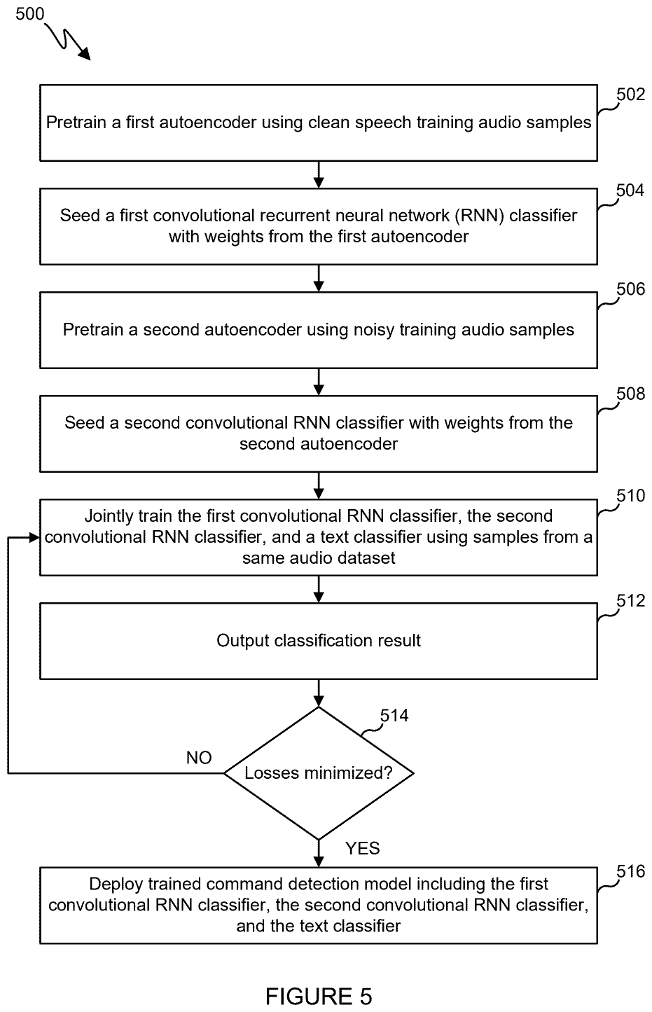

FIG. 5 illustrates an example method 500 for command detection model training in accordance with this disclosure. For ease of explanation, the method 500 shown in FIG. 5 is described as being implemented on or supported by the server 106 in the network configuration 100 of FIG. 1, and using the architecture 300 or 400. However, the method 500 shown in FIG. 5 could be used with any other suitable device(s) and in any other suitable system(s), such as when the method 500 is implemented on or supported by the electronic device 101.

At step 502, a first autoencoder, such as the first autoencoder 316, is pretrained using clean speech training audio samples. This can include the processor 120 providing clean speech audio samples, such as from a dataset like the clean speech samples 328, to an encoder of the first autoencoder, such as the first convolutional RNN encoder 318, to provide latent representations based on the audio samples, and using a decoder, such as the first convolutional RNN decoder 320, to reconstruct the audio signal. An error or loss (such as MSE) based on a comparison of the reconstructed signal and the original sample from the training dataset can be used to adjust the weights of the encoder of the first autoencoder. At step 504, a first convolutional RNN classifier, such as a first convolutional RNN classifier 304, is seeded with weights from the first autoencoder. This can include the processor 120 taking the weights from the encoder of the first autoencoder and copying those same weights over the weights of the first convolutional RNN classifier, such as also described with respect to FIG. 3.

At step 506, a second autoencoder, such as the second autoencoder 322, is pretrained using noisy training audio samples. This can include the processor 120 providing noisy audio samples, such as from a dataset like the noisy audio samples 330, to an encoder of the second autoencoder, such as the second convolutional RNN encoder 324, to provide latent representations based on the audio samples, and using a decoder, such as the second convolutional RNN decoder 326, to reconstruct the audio signal. An error or loss (such as MSE) based on a comparison of the reconstructed signal and the original sample from the training dataset can be used to adjust the weights of the encoder of the second autoencoder. At step 508, a second convolutional RNN classifier, such as a second convolutional RNN classifier 306, is seeded with weights from the second autoencoder. This can include the processor 120 taking the weights from the encoder of the second autoencoder and copying those same weights over the weights of the second convolutional RNN classifier, such as also described with respect to FIG. 3.

At step 510, the first convolutional RNN classifier, the second convolutional RNN classifier, and a text classifier, such as the text RNN classifier, of the command detection model are jointly trained using samples from a same audio dataset, such as the classification dataset 332. In some embodiments, the text classifier can be an RNN classifier, such as the text RNN classifier 310, trained with text transcripts from the audio dataset used to jointly train the classifiers. In some embodiments, the text classifier is first created by finetuning a pre-trained model, such as the external text model 402, with a dataset including text transcripts and then seeding the weights of the pre-trained model to the text classifier of the command detection model.

As described with respect to FIG. 3, this can include the processor 120 executing the command detection model, where the command detection model can include a first joint layer that combines the outputs of the first convolutional RNN classifier and the second convolutional RNN classifier. The output from the text classifier and the output from the first joint layer are then provided to a second joint layer, and, at step 512, a classification result, such as the classification results 314, is output using the second joint layer.

At step 514, it is determined whether the losses produced by comparing the classification result to the ground truths have the training dataset have been minimized to a level at which training of the command detection model can be completed. For example, this can include the processor 120, based on the output from the command detection model, determining an error or loss using a loss function and modifying the parameters of the command detection model, such as one or more of its components or sub-models, based on the error or loss. The loss function calculates the error or loss associated with the command detection model's predictions. For example, when the outputs of the command detection model differ from the ground truths, the differences can be used to calculate a loss as defined by the loss function. The loss function may use any suitable measure of loss associated with outputs generated by the command detection model, such as an MSE.

When the loss calculated by the loss function is larger than desired, the parameters of the command detection model can be adjusted. Once adjusted, the method 500 moves back to step 510 to provide the same or additional training data to the adjusted command detection model, and additional outputs provided at step 512 from the command detection model can be compared to the ground truths so that additional losses can be determined using the loss function. Over time, the command detection model produces more accurate outputs that more closely match the ground truths, and the measured loss becomes less. At some point, the measured loss drops below a specified threshold, and it can be determined at step 514 that the training of the command detection model can be completed. At step 516, the trained command detection model, including the first convolutional RNN classifier, the second convolutional RNN classifier, and the text classifier, is deployed.

For example, this can include providing a copy of the trained model to a client device (e.g., electronic device 101), such as a smartphone, for on-device execution of the command detection model, such as in conjunction with a voice assistant system running on the client device. That is, in various embodiments, the method 500 may be performed off the client device, such as by a server like the server 106, and the trained model is then deployed to one or more client devices. However, it will be understood that training could occur on any device, even on the client device, without departing from the scope of this disclosure.

Although FIG. 5 illustrates one example of a method 500 for command detection model training, various changes may be made to FIG. 5. For example, while shown as a series of steps, various steps in FIG. 5 could overlap, occur in parallel, occur in a different order, or occur any number of times (including zero times).

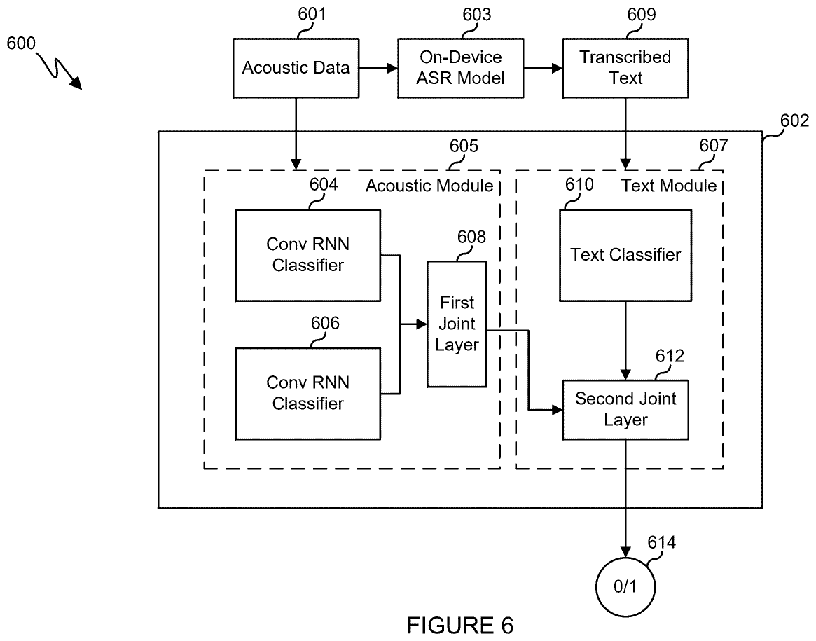

FIG. 6 illustrates an example command detection deployment architecture 600 in accordance with this disclosure. For ease of explanation, the architecture 600 shown in FIG. 6 is described as being implemented on or supported by the electronic device 101 in the network configuration 100 of FIG. 1. However, the architecture 600 shown in FIG. 6 could be used with any other suitable device(s) and in any other suitable system(s), such as when the architecture 600 is implemented on or supported by the server 106.

As shown in FIG. 6, the architecture 600 includes a trained command detection model 602, which can be the command detection model 202 described with respect to FIG. 2, and can correspond to the command detection model 302 of FIG. 3 prior to training. As shown in FIG. 6, when deployed, the command detection model 602 does not include the autoencoders 316, 322, as the autoencoders 316, 322 are just used during the pretraining step, as described with respect to FIG. 3.

The command detection model 602 includes a first convolutional RNN classifier 604 and a second convolutional RNN classifier 606. Acoustic data 601, such as that recorded by a device microphone, is processed by each of the first convolutional RNN classifier 604 and the second convolutional RNN classifier 606, and their outputs are combined using a first joint layer 608 using, for example, concatenation, cross attention, or context layers to create combined outputs from the outputs of the first convolutional RNN classifier 604 and the second convolutional RNN classifier 606. The first joint layer 608 can be considered a final fully connected layer of the first convolutional RNN classifier 604 and the second convolutional RNN classifier 606, taking as inputs the embeddings from the first convolutional RNN classifier 604 and the second convolutional RNN classifier 606, and outputting concatenated, cross-attention-based or context layer-based combination embeddings. The first convolutional RNN classifier 604, the second convolutional RNN classifier 606, and the first joint layer 608 logically can make up an acoustic module 605.

The architecture 600 also includes a text classifier 610 that processes text transcriptions. For example, the acoustic data 601 can be processed by an on-device ASR model 603 to create transcribed text 609. The transcribed text 609 is provided to the text classifier 610 and outputs from the text classifier 610 are provided to a second joint layer 612. The text classifier can correspond to the text RNN classifier 310 or the text classifier 410. The text classifier 610 and the second joint layer 612 can logically make up a text module 607. Thus, the acoustic data 601 is provided to the acoustic module 605 and the transcribed text 609 is provided to the text module 607. Outputs from the text classifier 610, as well as the combined outputs from the first joint layer 608, are provided to the second joint layer 612, to combine the outputs via a technique such as concatenation, cross attention, or context layers. In various embodiments, the first joint layer 608 and the second joint layer 612 can use the same combination technique, e.g., both use concatenation, or different techniques, e.g., the first joint layer 608 uses concatenation and the second joint layer 612 uses cross attention. The second joint layer 612 outputs a final audio classification result 614, to indicate whether the input audio is classified as intended audio (“1”) or unintended audio (e.g., background noise) (“0”). The second joint layer 612 can be considered a final fully connected layer of the text classifier 610 and first joint layer embeddings, taking as inputs the embeddings from the text classifier 610 and the first joint layer 608, and outputting a concatenated, cross-attention-based or context layer-based combination that provides the final audio classification result 614, i.e., a class decision label based on a confidence score.

Although FIG. 6 illustrates one example of a command detection deployment architecture 600, various changes may be made to FIG. 6. For example, various components and functions in FIG. 6 may be combined, further subdivided, replicated, or rearranged according to particular needs. Also, one or more additional components and functions may be included if needed or desired.

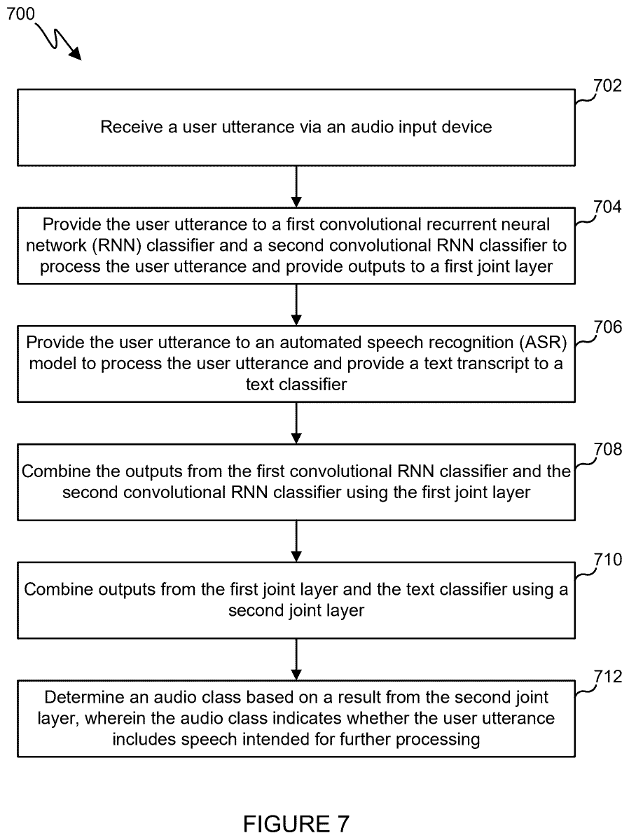

FIG. 7 illustrates an example method 700 for performing command detection in accordance with this disclosure. For ease of explanation, the method 700 shown in FIG. 7 is described as being performed using the electronic device 101 in the network configuration 100 of FIG. 1. However, the method 700 could be performed using any other suitable device(s), such as the server 106, and in any other suitable system(s).

At step 702, a user utterance is received via an audio input device, such as the audio input device 206. This can include the processor 120 controlling the audio input device to record sounds provided near the electronic device 101. At step 704, the user utterance is provided to a first convolutional RNN classifier and a second convolutional RNN classifier to process the user utterance and provide outputs to a first joint layer, such as the first joint layer 608. This can include the processor 120 providing acoustic data associated with utterance to the first convolutional RNN classifier 604 and the second convolutional RNN classifier 606 for processing the acoustic data and creating output embeddings from each of first convolutional RNN classifier and the second convolutional RNN classifier.

At step 706, the user utterance is provided to an ASR model, such as the ASR model 204 or 603, to process the user utterance and provide a text transcript to a text classifier, such as the text classifier 610, to create output embeddings using the text classifier. At step 708, the outputs from the first convolutional RNN classifier and the second convolutional RNN classifier are combined using the first joint layer. As described in this disclosure, this can include the processor 120 executing the first joint layer to combine the outputs from the first convolutional RNN classifier and the second convolutional RNN classifier using concatenation, cross attention, or context layers.

At step 710, outputs from the first joint layer and the text classifier are combined using a second joint layer, such as the second joint layer 612. As described in this disclosure, this can include the processor 120 executing the first joint layer to combine the outputs from the first joint layer and the text classifier using concatenation, cross attention, or context layers. As also described in this disclosure, the first joint layer and the second joint layer can use the same technique to combine the outputs, or different techniques. At step 712, an audio class (i.e., a classification result) is determined based on a result from the second joint layer, wherein the audio class indicates whether the user utterance includes speech intended for further processing. In various embodiments, the audio class is determined based on a confidence score output by the second joint layer. Based on the audio class, the processor 120 can determine whether the input audio should be ignored as unintended audio, or whether further action needs to be taken based on the audio being classified as intended audio, such as to cause a voice assistant of the electronic device 101 to answer a question posed in the input audio, ask a follow up question, or perform a device action requested in the input audio.

Although FIG. 7 illustrates one example of a method 700 for performing command detection, various changes may be made to FIG. 7. For example, while shown as a series of steps, various steps in FIG. 7 could overlap, occur in parallel, occur in a different order, or occur any number of times (including zero times).

It should be noted that the functions shown in FIGS. 2 through 7 or described above can be implemented in an electronic device 101, 102, 104, server 106, or other device(s) in any suitable manner. For example, in some embodiments, at least some of the functions shown in FIGS. 2 through 7 or described above can be implemented or supported using one or more software applications or other software instructions that are executed by the processor 120 of the electronic device 101, 102, 104, server 106, or other device(s). In other embodiments, at least some of the functions shown in FIGS. 2 through 7 or described above can be implemented or supported using dedicated hardware components. In general, the functions shown in FIGS. 2 through 7 or described above can be performed using any suitable hardware or any suitable combination of hardware and software/firmware instructions. Also, the functions shown in FIGS. 2 through 7 or described above can be performed by a single device or by multiple devices. For instance, the server 106 might be used to train the command detection model 302, and the server 106 could deploy the trained command detection model 602 to one or more other devices (such as the electronic device 101) for use.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
receiving a user utterance via an audio input device;
providing the user utterance to a first convolutional recurrent neural network (RNN) classifier and a second convolutional RNN classifier to process the user utterance and provide outputs to a first joint layer;
providing the user utterance to an automated speech recognition (ASR) model to process the user utterance and provide a text transcript to a text classifier;
combining the outputs from the first convolutional RNN classifier and the second convolutional RNN classifier using the first joint layer;
combining outputs from the first joint layer and the text classifier using a second joint layer; and
determining an audio class based on a result from the second joint layer, wherein the audio class indicates whether the user utterance includes speech intended for further processing.

2. The method of claim 1, wherein:
the first joint layer uses concatenation, cross attention, or context layers to combine the outputs from the first convolutional RNN classifier and the second convolutional RNN classifier; and
the second joint layer uses concatenation, cross attention, or context layers to combine the outputs from the first joint layer and the text classifier.

3. The method of claim 1, wherein:
the first convolutional RNN classifier is trained by performing pretraining of a first autoencoder that receives and processes clean speech training audio; and
the second convolutional RNN classifier is trained by performing pretraining of a second autoencoder that receives and processes noisy training audio.

4. The method of claim 3, wherein:
the first convolutional RNN classifier is provided with seed weights from the first autoencoder during training; and
the second convolutional RNN classifier is provided with seed weights from the second autoencoder during training.

5. The method of claim 4, wherein:
the first autoencoder includes a first convolutional RNN encoder to receive the clean speech training audio and a first convolutional RNN decoder to receive an output from the first convolutional RNN encoder; and
the second autoencoder includes a second convolutional RNN encoder to receive the noisy training audio, and a second convolutional RNN decoder to receive an output from the second convolutional RNN encoder.

6. The method of claim 5, wherein the convolutional RNN encoder is considered trained when a difference between input features to the convolutional RNN encoder and output features of the convolutional RNN decoder is minimized.

7. The method of claim 5, wherein the first convolutional RNN classifier, having the seed weights from the first autoencoder, the second convolutional RNN classifier, having the seed weights from the second autoencoder, and the text classifier are jointly trained using a same audio dataset, including:
the first convolutional RNN classifier the second convolutional RNN classifier are trained using audio samples from the same audio dataset, and
the text classifier is trained using text transcriptions created using the same audio dataset.

8. The method of claim 1, wherein the text classifier is one of:
an RNN classifier trained with a dataset including text transcripts; or
a text classifier created by finetuning a pre-trained model with a dataset including text transcripts.

9. The method of claim 1, wherein the audio class is determined based on a confidence score output by the second joint layer.

10. An electronic device comprising:
at least one processing device configured to:
receive a user utterance via an audio input device;
provide the user utterance to a first convolutional recurrent neural network (RNN) classifier and a second convolutional RNN classifier to process the user utterance and provide outputs to a first joint layer;
provide the user utterance to an automated speech recognition (ASR) model to process the user utterance and provide a text transcript to a text classifier;
combine the outputs from the first convolutional RNN classifier and the second convolutional RNN classifier using the first joint layer;
combine outputs from the first joint layer and the text classifier using a second joint layer; and
determine an audio class based on a result from the second joint layer, wherein the audio class indicates whether the user utterance includes speech intended for further processing.

11. The electronic device of claim 10, wherein:
the first joint layer uses concatenation, cross attention, or context layers to combine the outputs from the first convolutional RNN classifier and the second convolutional RNN classifier; and
the second joint layer uses concatenation, cross attention, or context layers to combine the outputs from the first joint layer and the text classifier.

12. The electronic device of claim 10, wherein:
the first convolutional RNN classifier is trained by performing pretraining of a first autoencoder that receives and processes clean speech training audio; and
the second convolutional RNN classifier is trained by performing pretraining of a second autoencoder that receives and processes noisy training audio.

13. The electronic device of claim 12, wherein:
the first convolutional RNN classifier is provided with seed weights from the first autoencoder during training; and
the second convolutional RNN classifier is provided with seed weights from the second autoencoder during training.

14. The electronic device of claim 13, wherein:
the first autoencoder includes a first convolutional RNN encoder configured to receive the clean speech training audio and a first convolutional RNN decoder configured to receive an output from the first convolutional RNN encoder; and
the second autoencoder includes a second convolutional RNN encoder configured to receive the noisy training audio, and a second convolutional RNN decoder configured to receive an output from the second convolutional RNN encoder.

15. The electronic device of claim 14, wherein the convolutional RNN encoder is considered trained when a difference between input features to the convolutional RNN encoder and output features of the convolutional RNN decoder is minimized.

16. The electronic device of claim 14, wherein the first convolutional RNN classifier, having the seed weights from the first autoencoder, the second convolutional RNN classifier, having the seed weights from the second autoencoder, and the text classifier are jointly trained using a same audio dataset, including:
the first convolutional RNN classifier the second convolutional RNN classifier are trained using audio samples from the same audio dataset, and
the text classifier is trained using text transcriptions created using the same audio dataset.

17. The electronic device of claim 10, wherein the text classifier is one of:
an RNN classifier trained with a dataset including text transcripts; or
a text classifier created by finetuning a pre-trained model with a dataset including text transcripts.

18. The electronic device of claim 10, wherein the audio class is determined based on a confidence score output by the second joint layer.

19. A non-transitory machine readable medium comprising instructions that when executed cause at least one processor of an electronic device to:
receive a user utterance via an audio input device;
provide the user utterance to a first convolutional recurrent neural network (RNN) classifier and a second convolutional RNN classifier to process the user utterance and provide outputs to a first joint layer;
provide the user utterance to an automated speech recognition (ASR) model to process the user utterance and provide a text transcript to a text classifier;
combine the outputs from the first convolutional RNN classifier and the second convolutional RNN classifier using the first joint layer;
combine outputs from the first joint layer and the text classifier using a second joint layer; and
determine an audio class based on a result from the second joint layer, wherein the audio class indicates whether the user utterance includes speech intended for further processing.

20. The non-transitory machine readable medium of claim 19, wherein:
the first joint layer uses concatenation, cross attention, or context layers to combine the outputs from the first convolutional RNN classifier and the second convolutional RNN classifier; and
the second joint layer uses concatenation, cross attention, or context layers to combine the outputs from the first joint layer and the text classifier.
